(19) United States
(12) Patent Application Publication
(10) Pub. No.: US 2025/0391116 A1
(43) Pub. Date: Dec. 25, 2025

(54) TILED OPTIMIZATION FOR VEHICLE TRACE DATA

(71) Applicant: TOYOTA JIDOSHA KABUSHIKI KAISHA, TOYOTA-SHI (JP)

(72) Inventors: Paul J. Ozog, Ann Arbor, MI (US); Mohamed Aladem, Ypsilanti, MI (US); Yucong Lin, Ann Arbor, MI (US); Matthew Dreisbach, Ann Arbor, MI (US); Chong Zhang, Burr Ridge, IL (US); Hai Jin, Fremont, CA (US)

(21) Appl. No.: 18/751,065

(22) Filed: Jun. 21, 2024

(51) Int. Cl. G06T 17/20; G06T 7/149

(52) U.S. Cl. CPC G06T 17/205; G06T 7/149

(57) ABSTRACT

Systems and methods of optimizing vehicle trace data for generating digital representations of road networks are provided. For example, a methodology of the presently disclosed technology may comprise: (1) segmenting vehicle trace data into a first set of tile groups; (2) applying an optimization algorithm to the first set of tile groups; (3) segmenting the vehicle trace data into a second set of tile groups, wherein geospatial arrangement of the second set of tile groups is shifted with respective to geospatial arrangement of the first set of tile groups; (4) applying the optimization algorithm to the second set of tile groups; and (5) generating a representation of an environment based on the application of the optimization algorithm to the first and second sets of tile groups.

### TECHNICAL FIELD

The present disclosure relates generally to automotive systems and technologies. More particularly, some embodiments relate to optimizing vehicle trace data for generating a digital representation of an environment.

### DESCRIPTION OF RELATED ART

Vehicle sensors (e.g., imaging and proximity sensors, gyroscopes, odometers, etc.) can collect information about a vehicle and the vehicle's surroundings. Such data can be used to generate a digital representation (e.g., a geometry map) of an environment surrounding the vehicle. For example, a system may mount an imaging sensor (e.g., a camera) to a vehicle in motion within an environment. The system can use image data generated by the imaging sensor to generate a digital representation of the environment.

Simultaneous Localization and Mapping (“SLAM”) is one technique for generating such a digital representation. A SLAM system can generate a digital representation of an environment while simultaneously tracking location of a vehicle within that environment.

Vehicle trace data is a type of data utilized by SLAM systems (and other similar systems) to generate a digital representation of an environment. As used herein, vehicle trace data may refer to any combination of: (1) data related to a three-dimensional (3D) trajectory of a vehicle (e.g., vehicle location, vehicle pose, etc.) as the vehicle traverses an environment; and (2) data related to landmarks (e.g., lane markers, road boundaries, road signs, etc.) observed by vehicle sensors as the vehicle traverses the environment. Often, a SLAM system will utilize vehicle trace data obtained from many vehicles (e.g., thousands of vehicles) to generate a digital representation of an environment. Utilizing vehicle trace data from many vehicles can be helpful for generating a more complete digital representation of a large environment. However, such vehicle trace data—along with digital representations generated from the vehicle trace data—can be “fuzzy” due to discrepancies in observations among vehicles.

To reduce “fuzziness” in vehicle trace data (and to improve crispness of a digital representation generated from the vehicle trace data), a SLAM system typically applies an optimization algorithm to the vehicle trace data. Application of the optimization algorithm to the vehicle trace data often involves matrix operations.

### BRIEF SUMMARY OF THE DISCLOSURE

According to various embodiments of the disclosed technology, a method is provided. The method may comprise: (1) segmenting vehicle trace data into a first set of tile groups; (2) applying an optimization algorithm to the first set of tile groups; (3) applying the optimization algorithm to the second set of tile groups; and (4) generating a digital representation of an environment based on an application of the optimization algorithm to the first and second sets of tile groups.

In some embodiments of the method, applying the optimization algorithm to the first set of tile groups may comprise independently applying the optimization algorithm to individual tile groups in the first set of tile groups.

In certain embodiments of the method, the first and second tile groups may be arranged on a geospatial grid of hexagonal tiles, and a respective tile group may comprise a cluster of adjacent hexagonal tiles on the geospatial grid of hexagonal tiles. In some embodiments, a respective hexagonal tile on the geospatial grid of hexagonal tiles may correspond to a contiguous geographic region of the environment. In certain embodiments, the cluster of adjacent hexagonal tiles may comprise a central hexagonal tile surrounded by six hexagonal tiles adjacent the central hexagonal tile. In some of such embodiments, central hexagon tiles for the second set of tile groups may be shifted by at least one tile position on the geospatial grid of hexagonal tiles with respect to central hexagon tiles for the first set of tile groups.

In various embodiments of the method, the method may further comprise: (1) segmenting the vehicle trace data into a third set of tile groups, wherein geospatial arrangement of the third set of tile groups is shifted with respective to geospatial arrangement of the first and second sets of tile groups; (2) applying the optimization algorithm to the third set of tile groups; (3) segmenting the vehicle trace data into a fourth set of tile groups, wherein geospatial arrangement of the fourth set of tile groups is shifted with respective to geospatial arrangement of the first, second, and third sets of tile groups; (4) applying the optimization algorithm to the fourth set of tile groups; (5) segmenting the vehicle trace data into a fifth set of tile groups, wherein geospatial arrangement of the fifth set of tile groups is shifted with respective to geospatial arrangement of the first, second, third, and fourth sets of tile groups; and (6) applying the optimization algorithm to the fifth set of tile groups. Here, in certain embodiments generating the representation of the environment based on the application of the optimization algorithm to the first and second sets of tile groups may comprise generating the representation of the environment based on the application of the optimization algorithm to the first, second, third, fourth, and fifth sets of tile groups.

In some embodiments of the method, the optimization algorithm may comprise a simultaneous localization and mapping (SLAM) algorithm.

In certain embodiments of the method, the vehicle trace data may be obtained from connected vehicles.

In various embodiments of the method, the vehicle trace may data comprises at least one of: (a) data related to three-dimensional (3D) trajectories of the connected vehicles; or (b) data related to landmarks observed by the connected vehicles along their 3D trajectories.

In various embodiments, a system is provided. The system may comprise: (1) one or more processing resources; and (2) non-transitory computer-readable medium, coupled to the one or more processing resources, comprising stored therein instructions that when executed by the one or more processing resources cause the system to: (a) segment vehicle trace data into a first set of tile groups; (b) independently apply an optimization algorithm to individual tile groups in the first set of tile groups; (c) segment the vehicle trace data into a second set of tile groups, wherein geospatial arrangement of the second set of tile groups is shifted with respective to geospatial arrangement of the first set of tile groups; (d) independently apply the optimization algorithm to individual tile groups in the second set of tile groups; and (e) generate a representation of an environment based on an application of the optimization algorithm to the first and second sets of tile groups.

In some embodiments of the system, the non-transitory computer-readable medium may comprise further instructions, that when executed by the one or more processing resources, cause the system to: (a) segment the vehicle trace data into a third set of tile groups, wherein geospatial arrangement of the third set of tile groups is shifted with respective to geospatial arrangement of the first and second sets of tile groups; (b) independently apply the optimization algorithm to individual tile groups in the third set of tile groups; (c) segment the vehicle trace data into a fourth set of tile groups, wherein geospatial arrangement of the fourth set of tile groups is shifted with respective to geospatial arrangement of the first, second, and third sets of tile groups; (d) independently apply the optimization algorithm to individual tile groups in the fourth set of tile groups; (e) segment the vehicle trace data into a fifth set of tile groups, wherein geospatial arrangement of the fifth set of tile groups is shifted with respective to geospatial arrangement of the first, second, third, and fourth sets of tile groups; and (f) independently apply the optimization algorithm to individual tile groups in the fifth set of tile groups. In certain of such embodiments, generating the representation of the environment based on the application of the optimization algorithm to the first and second sets of tile groups may comprise generating the representation of the environment based on the application of the optimization algorithm to the first, second, third, fourth, and fifth sets of tile groups.

In various embodiments another method is provided. The method may comprise: (1) segmenting vehicle trace data into a first set of tile groups; (2) independently applying an optimization algorithm to individual tile groups in the first set of tile groups; (3) segmenting the vehicle trace data into a second set of tile groups wherein: (a) the first and second tile groups are arranged on a geospatial grid of hexagonal tiles, (b) a respective tile group comprises a central hexagonal tile surrounded by six hexagonal tiles adjacent the central hexagonal tile, and (c) central hexagon tiles for the second set of tile groups are shifted by at least one tile position on the grid of hexagonal tiles with respect to central hexagon tiles for the first set of tile groups; (4) independently applying the optimization algorithm to individual tile groups in the second set of tile groups; and (5) generating a representation of an environment based on the application of the optimization algorithm to the first and second sets of tile groups.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A-1B illustrate an example architecture for optimizing vehicle trace data and generating a digital representation of an environment, in accordance with various embodiments of the presently disclosed technology.

FIG. 2 illustrates a comparison between digital representations of an environment before and after optimization of vehicle trace data, in accordance with various embodiments of the presently disclosed technology.

FIG. 3 illustrates a graphical representation of vehicle trace data, in accordance with various embodiments of the presently disclosed technology.

FIG. 4A illustrates the vehicle trace data from FIG. 3 segmented into a first set of tile groups, in accordance with various embodiments of the presently disclosed technology.

FIG. 4B illustrates the vehicle trace data from FIG. 3 segmented into a second set of tile groups, in accordance with various embodiments of the presently disclosed technology.

FIG. 5 illustrates an example process that can be performed by a system to optimize vehicle trace data for generating a digital representation of an environment, in accordance with various embodiments of the presently disclosed technology.

FIG. 6 is an example computing component that may be used to implement various features of embodiments described in the present disclosure.

The figures are not exhaustive and do not limit the present disclosure to the precise form disclosed.

### DETAILED DESCRIPTION

As described above, a SLAM system (and other similar systems) can generate a digital representation of an environment (e.g., a geometry map) while simultaneously tracking a location of a vehicle within that environment. Often, the SLAM system will utilize vehicle trace data obtained from many vehicles (e.g., hundreds, or thousands of vehicles, or more) to generate the digital representation of the environment. Utilizing vehicle trace data from many vehicles can be helpful for generating a more complete digital representation of a large environment. However, such vehicle trace data-along with digital representations generated from such vehicle trace data—can be “fuzzy” due to discrepancies in observations among vehicles. To reduce “fuzziness” in vehicle trace data (and to improve crispness of a digital representation generated from the vehicle trace data), the SLAM system can apply an optimization algorithm to the vehicle trace data. Application of the optimization algorithm to the vehicle trace data often involves matrix operations.

The above-described optimization process can become extremely time and resource intensive when a SLAM system is used to map a large environment (i.e., an environment spanning a large geographic region). For example, storing a matrix representation of vehicle trace data for a large geographic region such as the United States can require an enormous amount of computer memory—which will generally far exceed the storage capacity of a single computer. Relatedly, using conventional techniques to apply an optimization algorithm to this enormous amount of data/enormous matrix—and solving the resultant (enormous) optimization problem—can be extremely time and resource intensive, or even infeasible. For this reason, utilizing SLAM systems to map large environments presents a significant challenge.

Against this backdrop, aspects of the presently disclosed technology may be implemented to reduce the amount of time a SLAM system (or similar mapping system) takes to run an optimization algorithm by: (1) segmenting vehicle trace data into smaller geographic partitions (e.g., tile groups); and (2) applying the optimization algorithm to the smaller geographic partitions independently, and in parallel. In this way, embodiments can break a single large optimization problem into multiple smaller optimization problems which can be solved more quickly (and in some cases with fewer processing resources).

For example, a system of the presently disclosed technology may segment vehicle trace data into a set of tile groups, with a respective tile group comprising a cluster of adjacent tiles. The vehicle trace data (in its entirety) may correspond to a large geographic region (e.g., the United States). The respective tile group may correspond to a smaller geographic region (e.g., a contiguous 1 kilometer region) within the large geographic region. Vehicle trace data for the respective tile group may be represented using a separate matrix from other matrices used to represent vehicle trace data for other tile groups. By applying an optimization algorithm to respective tile groups/matrices independently and in parallel, the system can solve the resultant (smaller) optimization problems more quickly than conventional technologies which do not segment the vehicle trace data into tiles groups. In other words, conventional technologies which represent the vehicle trace data as a single (enormous) matrix and solve a single (enormous) optimization problem, will generally take longer than the system of the presently disclosed technology which segments vehicle trace data into tile groups. Moreover, such segmentation can facilitate easier scaling up for memory storage of the vehicle trace data. For example, a respective computing resource can be used to store a subset of tile groups, and additional computing resources can be added in a modular fashion to store additional subsets of tile groups as needed.

However, the above-referenced tile group segmentation can create additional challenges. Namely (and as embodiments are designed in appreciation of), discontinuities can appear at borders between tile groups due to the independent optimization of the tile groups. For example, digital representations of landmarks (e.g., lane markers, road boundaries, etc.) may shift with respective to each other across independently-optimized adjacent tile groups. Accordingly, digital representations of the landmarks may be misaligned at borders of the adjacent tile groups. Such misalignment (and other similar defects) may cause safety and other issues with operation of a vehicle that relies on the digital representation(s) for navigation and other tasks (e.g., autonomous driving).

To address this challenge raised by segmenting vehicle trace data into tile groups, implementations may be configured to perform multiple iterations of the above-described segmented optimization while shifting geospatial arrangement of the tile groups between iterations. By shifting geospatial arrangement of the tile groups between iterations, embodiments can effectively “smooth out” discontinuities at tile group borders by effectively varying tile group borders across iterations. In certain examples, embodiments may perform a predetermined number of iterations to ensure that each tile group border in a respective iteration is wholly contained within a tile group (and thus not a tile group border) in at least one other iteration.

For example, a system of the presently disclosed technology may segment vehicle trace data into a first set of tile groups. The system may then apply (independently, and in parallel) an optimization algorithm to the first set of tile groups. However, and as alluded to above, there may be discontinuities at borders between the first set of tile groups due to their independent optimization. To effectively “smooth out” these discontinuities, the system can segment the vehicle trace data into a second set of tile groups, wherein geospatial arrangement of the second set of tile groups is shifted with respective to geospatial arrangement of the first set of tile groups. Such shifting effectively varies location/arrangement of tile group borders between the first set of tile groups and the second set of tile groups. The system can then apply (independently, and in parallel) the optimization algorithm to the second set of tile groups. After a predetermined number of iterations have been performed (e.g., to ensure that each tile group border in a respective iteration is wholly contained within a tile group in at least one other iteration), the system can generate a digital representation of an environment based on the application of the optimization algorithm to the tile groups in the previously performed iterations. The system may generate this digital representation more quickly (and in some cases with fewer processing resources) than conventional technologies which do not segment the vehicle trace data into tile groups prior to optimization. Relatedly, the digital representation may be smoother/more accurate than digital representations generated by alternative technologies which do not perform multiple iterations of the above-described segmented optimization while shifting geospatial arrangement of tile groups between iterations.

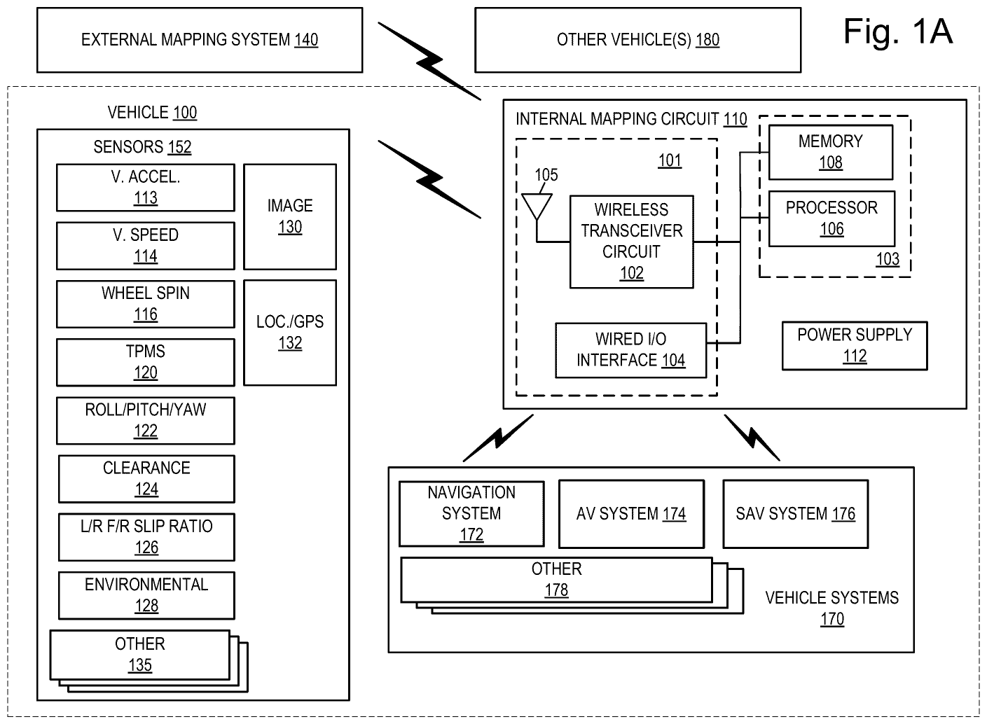

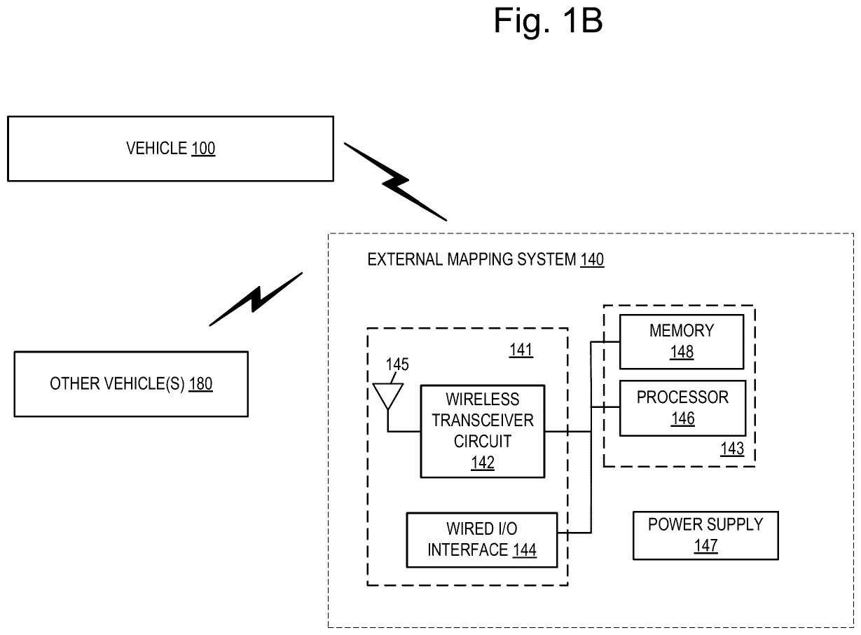

The systems and methods disclosed herein may be implemented with any of a number of different vehicles and vehicle types. For example, the systems and methods disclosed herein may be used with automobiles, trucks, motorcycles, recreational vehicles and other types of vehicles. In addition, the principles disclosed herein may be utilized by systems which are external from vehicles (e.g., external mapping system 140 of FIGS. 1A-1B).

FIGS. 1A-1B illustrate an example architecture for optimizing vehicle trace data and generating a digital representation of an environment, in accordance with various embodiments of the presently disclosed technology.

As depicted, the example architecture includes a vehicle 100 (depicted in greater detail in FIG. 1A), an external mapping system 140 (depicted in greater detail in FIG. 1B), and other vehicle(s) 180. Vehicle 100, external mapping system 140, and other vehicle(s) 180 can communicate with each other via wireless communication.

Before describing individual components of vehicle 100 and external mapping system 140 in more detail, a high level operational overview may be useful.

In certain embodiments, external mapping system 140 can obtain vehicle trace data from vehicle 100 and other vehicle(s) 180. Other vehicle(s) 180 may include any number of vehicle (e.g., on the order of thousands of vehicles).

As described above, the vehicle trace data may comprise any combination of: (1) data related to three-dimensional (3D) trajectories of vehicle 100 and other vehicle(s) 180 as the vehicles traverse an environment; and (2) data related to landmarks (e.g., lane markers, road boundaries, road signs, traffic lights, and other landmarks/features of the environment) observed by sensors of vehicle 100 and other vehicle(s) 180 as the vehicles traverse the environment. External mapping system 140 can utilize such vehicle trace data to generate a digital representation of the environment. In some embodiments, external mapping system 140 can also utilize such vehicle trace data to simultaneously localize vehicle 100 and other vehicle(s) 180. In certain of these embodiments, external mapping system 140 may utilize Simultaneous Localization and Mapping (“SLAM”) techniques for this purpose.

In some embodiments, internal mapping circuit 110 of vehicle 100 can also utilize vehicle trace data-obtained from any combination of sensors 152 of vehicle 100, external mapping system 140, and other vehicle(s) 180—to generate a digital representation of the environment surrounding vehicle 100. In some embodiments, internal mapping circuit 110 can also utilize such vehicle trace data to localize vehicle 100 simultaneously. In certain of these embodiments, internal mapping circuit 110 may utilize SLAM techniques for this purpose.

In various embodiments, either or both of external mapping system 140 and internal mapping circuit 110 may perform the above-described mapping and localization. In addition to mapping and localization, external mapping system 140 and internal mapping circuit 110 may also utilize data association techniques to identify/determine landmarks. Such data association techniques may also be used to fuse data obtained from different vehicles and different types of vehicle sensors. Such data association techniques may involve analyzing time stamps for sensor data, generating and analyzing covariance matrices which represent sensor uncertainty, and so on.

Referring now to vehicle 100 and FIG. 1A in more detail, as depicted, vehicle 100 comprises an internal mapping circuit 110, sensors 152, and vehicle systems 170. Sensors 152 and vehicle systems 170 can communicate with internal mapping circuit 110 via a wired or wireless communication interface. Although sensors 152 and vehicle systems 170 are depicted as communicating with internal mapping circuit 110, they can also communicate with each other. Internal mapping circuit 110 can be implemented as an electronic control unit (ECU) or as part of an ECU. In other embodiments, internal mapping circuit 110 can be implemented independently of an ECU.

As alluded to above, internal mapping circuit 110 can utilize vehicle trace data-obtained from any combination of sensors 152, external mapping system 140, and other vehicle(s) 180—to generate a digital representation of an environment surrounding vehicle 100. In some embodiments, internal mapping circuit 110 can simultaneously localize vehicle 100 within that environment as well. In certain embodiments, internal mapping circuit 110 can utilize SLAM techniques for this purpose.

In the specific example of FIG. 1A, internal mapping circuit 110 includes a communication circuit 101, a decision circuit 103 (including a processor 106 and a memory 108), and a power supply 112. Components of internal mapping circuit 110 are illustrated as communicating with each other via a data bus, although other interfaces can be included.

Processor 106 can include one or more general processing units (GPUs), central processing units (CPUs), microprocessors, or any other suitable processing system. Processor 106 may include a single core processor or multicore processors. Memory 108 may include one or more various forms of memory or data storage (e.g., flash, RAM, etc.) that may be used to store vehicle trace data (including matrices representing vehicle trace data), calibration parameters, images (analysis or historic), point parameters, instructions and variables for processor 106 as well as any other suitable information. Memory 108, can be made up of one or more modules of one or more different types of memory, and may be configured to store data and other information as well as operational instructions that may be used by processor 106.

Although the example of FIG. 1A is illustrated using processor and memory circuitry, in various embodiments decision circuit 103 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up internal mapping circuit 110.

Communication circuit 101 can utilize a wireless transceiver circuit 102 with an associated antenna 105 for wireless communication. Communication circuit 101 can also utilize a wired I/O interface 104 with an associated hardwired data port (not illustrated). As this example illustrates, communications with internal mapping circuit 110 can include either or both wired and wireless communications. Wireless transceiver circuit 102 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 105 is coupled to wireless transceiver circuit 102 and is used by wireless transceiver circuit 102 to transmit radio signals wirelessly to wireless equipment and to receive radio signals as well. These radio signals can include information of almost any sort that is sent or received by internal mapping circuit 110 to/from other entities such as sensors 152, vehicle systems 170, external mapping system 140, and other vehicle(s) 180.

Wired I/O interface 104 can include a transmitter and a receiver (not shown) for hardwired communications with other devices. For example, wired I/O interface 104 can provide a hardwired interface to other components, including sensors 152 and vehicle systems 170. Wired I/O interface 104 can communicate with other devices using Ethernet or any of a number of other wired communication protocols whether standardized, proprietary, open, point-to-point, networked or otherwise.

Power supply 112 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 152 can include, for example, vehicle acceleration sensors 113, vehicle speed sensors 114, wheelspin sensors 116 (e.g., one for each wheel), a tire pressure monitoring system (TPMS) 120, accelerometers such as a 3-axis accelerometer 122 to detect roll, pitch and yaw of the vehicle, vehicle clearance sensors 124, left-right and front-rear slip ratio sensors 126, environmental sensors 128 (e.g., to detect salinity or other environmental conditions), image sensor(s) 130, and location sensor(s) 132. Other sensors 135 can also be included as may be appropriate for a given implementation of vehicle 100. For example other sensors 135 may include gyroscopes, odometers, etc.

In some embodiments, image sensor(s) 130 may comprise one or more cameras configured to generate image data of an environment surrounding vehicle 100. The image data may comprise images of the environment.

In certain embodiments, location sensor(s) 132 may comprise a global navigation satellite sensor, a global position sensor, or other types of vehicle positioning sensors. Location sensor(s) 132 may be configured to generate location data for vehicle 100 and/or location data for landmarks in the environment surrounding vehicle 100. The location data may comprise precise coordinates (e.g., latitude, longitude, and altitude) of vehicle 100's position or the position(s) of landmark(s) on the Earth's surface.

In some embodiments, one or more of sensors 152 may include their own processing capability to compute the results for additional information that can be provided to internal mapping circuit 110. In other embodiments, one or more of sensors 152 may be data-gathering-only sensors that only provide raw data to internal mapping circuit 110. In further embodiments, one or more hybrid sensors may be included that provide a combination of raw data and processed data to internal mapping circuit 110. Sensors 152 may provide analog outputs, digital outputs, or a combination of both.

As alluded to above, vehicle trace data for vehicle 100 can be obtained using sensors 152.

Vehicle systems 170 can include any of a number of different vehicle components or subsystems used to control or monitor various aspects of vehicle 100 and its performance. For example, vehicle systems 170 may include any one or combination of a navigation system 172, an autonomous vehicle (AV) system 174, a semi-autonomous vehicle (SAV) system 176, and other vehicle systems 178.

In general, AV and SAV systems (e.g., AV system 174 and SAV system 176) can control driving behaviors of a vehicle. AV and SAV systems can interpret sensory information, identify appropriate traffic configurations, determine vehicle navigation paths, and actuate vehicle systems in accordance with determined vehicle navigation paths. Many AV and SAV systems are directed systems that minimize vehicle collisions.

As alluded to above, AV and SAV systems (e.g., AV system 174 and SAV system 176) can leverage a digital representation of a vehicle's environment to determine vehicle navigation paths. In general, improved accuracy of the digital representation can result in improved decision making for an AV/SAV system leveraging the digital representation. Accordingly, AV system 174 and SAV system 176 can leverage rapidly generated and accurate digital representations-provided by internal mapping circuit 110 and/or external mapping system 140—for improved autonomous/semi-autonomous driving performance. Relatedly, navigation system 172 can leverage such digital representations for improved navigation displays.

Referring now to external mapping system 140 and FIG. 1B in more detail, as depicted, external mapping system 140 may comprise a communication circuit 141, a decision circuit 143, and a power supply 147. Components of external mapping system 140 are illustrated as communicating with each other via a data bus, although other interfaces can be included.

Similar to decision circuit 101 of vehicle 100, decision circuit 143 may comprise a processor 146 and a memory 148. Processor 146 can include one or more general processing units (GPUs), central processing units (CPUs), microprocessors, or any other suitable processing system. Processor 146 may include a single core processor or multicore processors. Memory 148 may include one or more various forms of memory or data storage (e.g., flash, RAM, etc.) that may be used to store vehicle trace data (including matrices representing vehicle trace data), calibration parameters, images (analysis or historic), point parameters, instructions and variables for processor 146 as well as any other suitable information. Memory 148, can be made up of one or more modules of one or more different types of memory, and may be configured to store data and other information as well as operational instructions that may be used by processor 146.

Although the example of FIG. 1B is illustrated using processor and memory circuitry, in various embodiments decision circuit 143 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up external mapping system 140.

Similar to communication circuit 101 of vehicle 100, communication circuit 141 can utilize a wireless transceiver circuit 142 with an associated antenna 145 for wireless communication. Communication circuit 141 can also utilize a wired I/O interface 144 with an associated hardwired data port (not illustrated). As this example illustrates, communications with external mapping system 140 can include either or both wired and wireless communications. Wireless transceiver circuit 142 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 145 is coupled to wireless transceiver circuit 142 and is used by wireless transceiver circuit 142 to transmit radio signals and to receive radio signals as well. These radio signals can include information of almost any sort that is sent or received by external mapping system 140 to/from other entities such as vehicle 100 and other vehicle(s) 180.

Wired I/O interface 184 can include a transmitter and a receiver (not shown) for hardwired communications with other devices. For example, wired I/O interface 184 can provide a hardwired interface to other components of external mapping system 140. Wired I/O interface 144 can communicate with other devices using Ethernet or any of a number of other wired communication protocols whether standardized, proprietary, open, point-to-point, networked or otherwise.

Power supply 142 can include one or more of a battery or batteries (such as, e.g., Li-ion, Li-Polymer, NiMH, NiCd, NiZn, and NiH2, to name a few, whether rechargeable or primary batteries,), a power connector, an energy harvester (e.g., solar cells, piezoelectric system, etc.), or it can include any other suitable power supply.

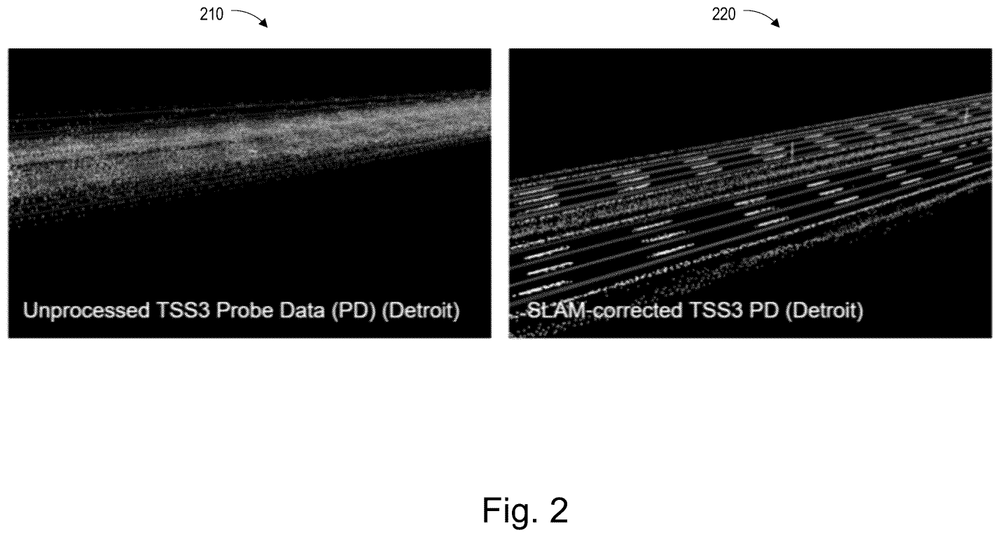

FIG. 2 illustrates a comparison between digital representations of an environment before and after optimization of vehicle trace data, in accordance with various embodiments of the presently disclosed technology.

Before describing FIG. 2 in detail, some background may be helpful.

As described above, vehicle sensors (e.g., imaging and proximity sensors, gyroscopes, odometers, etc.) can collect information about a vehicle (e.g., vehicle 100 from FIGS. 1A-1B) and the vehicle's surroundings. Such data can be used to generate a digital representation (e.g., a geometry map) of an environment surrounding the vehicle. For example, a system may mount an imaging device (e.g., a camera) to a vehicle in motion within an environment. The system can use image data generated by the imaging device to generate a digital representation of the environment.

Simultaneous Localization and Mapping (“SLAM”) is one technique for generating such a digital representation. A SLAM system can generate a digital representation of an environment while simultaneously tracking location of a vehicle within that environment.

Vehicle trace data is a type of data utilized by SLAM systems (and other similar systems) to generate a digital representation of an environment. As used herein, vehicle trace data may refer to any combination of: (1) data related to a three-dimensional (3D) trajectory of a vehicle as the vehicle traverses an environment; and (2) data related to landmarks observed by vehicle sensors as the vehicle traverses the environment. Often, a SLAM system will utilize vehicle trace data obtained from many vehicles (e.g., thousands of vehicles) to map an environment. Utilizing vehicle trace data from many vehicles can be helpful for generating a more complete digital representation of a large environment. However, such vehicle trace data-along with digital representation generated from such vehicle trace data—can be “fuzzy” due to discrepancies in observations among vehicles.

To reduce “fuzziness” in vehicle trace data (and to improve crispness of a digital representation generated from the vehicle trace data), a SLAM system typically applies an optimization algorithm to the vehicle trace data. Application of the optimization algorithm to the vehicle trace data often involves matrix operations.

Referring now to FIG. 2, representation 210 depicts a digital representation of an environment—in this specific example, a multi-lane highway—based on vehicle trace data before the vehicle trace data has been optimized. The vehicle trace data in this example was obtained from many vehicles/many vehicle sensors. For this reason, representation 210 (which depicts the digital representation of the multi-lane highway generated from the vehicle trace data) appears “fuzzy” due to discrepancies in observations among the many vehicles/many vehicle sensors.

Representation 220 depicts a digital representation of the multi-lane highway based on an optimized version of the vehicle trace data (i.e., after an optimization algorithm has been applied to the vehicle trace data). In various embodiments, the optimization algorithm may comprise a SLAM algorithm.

As can been seen in FIG. 2, representation 220 depicts the multi-lane highway segment more crisply than representation 210. Again, this is due to the optimization of the vehicle trace data.

However, the above-described optimization process can become extremely time and resource intensive when a SLAM system (or similar mapping system) is used to map a large environment (i.e., an environment spanning a large geographic region). For example, storing a matrix representation of vehicle trace data for a large geographic region such as the United States can require an enormous amount of computer memory—which will generally far exceed the storage capacity of a single computer. Relatedly, using conventional techniques to apply an optimization algorithm to this enormous amount of data/enormous matrix—and solving the resultant (enormous) optimization problem—can be extremely time and resource intensive, or even infeasible. For this reason, utilizing SLAM systems to map large environments presents a significant challenge.

As described above, embodiments of the presently disclosed technology reduce the amount of time a SLAM system (or similar mapping system) takes to run an optimization algorithm by: (1) segmenting vehicle trace data into smaller partitions (e.g., tile groups); and (2) applying the optimization algorithm to the smaller partitions independently, and in parallel. In this way, embodiments can break a single large optimization problem into multiple smaller optimization problems which can be solved more quickly (and in some cases with fewer processing resources).

For example, a system of the presently disclosed technology may segment vehicle trace data into a set of tile groups, with a respective tile group comprising a cluster of adjacent tiles. The vehicle trace data (in its entirety) may correspond to a large geographic region (e.g., the United States). The respective tile group may correspond to a smaller geographic region (e.g., a contiguous 1 kilometer region) within the large geographic region. As alluded to above, vehicle trace data for the respective tile group may be represented using a separate matrix from other matrices used to represent vehicle trace data for other tile groups. By applying an optimization algorithm to respective tile groups/matrices independently and in parallel, the system can solve the resultant (smaller) optimization problems more quickly than conventional technologies which do not segment the vehicle trace data into tiles groups. In other words, conventional technologies which represent the vehicle trace data as a single (enormous) matrix and solve a single (enormous) optimization problem, will generally take longer than the system of the presently disclosed technology which segments vehicle trace data into tile groups. Moreover, such segmentation can facilitate easier scaling up for memory storage of the vehicle trace data. For example, a respective computing resource can be used to store a subset of tile groups, and additional computing resources can be added in a modular fashion to store additional subsets of tile groups as needed.

However, the above-referenced segmentation technique can create additional challenges. Namely (and as embodiments are designed in appreciation of), discontinuities can appear at the borders between tile groups due to their independent optimization. For example, digital representations of landmarks (e.g., lane markers, road boundaries, etc.) may shift with respective to each other across independently-optimized adjacent tile groups. Accordingly, digital representations of the landmarks may be misaligned at borders of the adjacent tile groups. Such misalignment (and other similar defects) may cause safety and other issues with operation of a vehicle that relies on the digital representation(s) for navigation and other tasks (e.g., autonomous driving).

To address this challenge raised by segmenting vehicle trace data into tile groups, embodiments perform multiple iterations of the above-described segmented optimization while shifting geospatial arrangement of the tile groups between iterations. By shifting geospatial arrangement of the tile groups between iterations, embodiments can effectively “smooth out” discontinuities at tile group borders by effectively varying tile group borders across iterations. In certain examples, embodiments may perform a predetermined number of iterations to ensure that each tile group border in a respective iteration is wholly contained within a tile group (and thus not a tile group border) in at least one other iteration.

For example, a system of the presently disclosed technology (e.g., external mapping system 140) may segment vehicle trace data into a first set of tile groups. The system may then apply (independently, and in parallel) an optimization algorithm to the first set of tile groups. However, and as alluded to above, there may be discontinuities at borders between the first set of tile groups due to their independent optimization. To effectively “smooth out” these discontinuities, the system can segment the vehicle trace data into a second set of tile groups, wherein geospatial arrangement of the second set of tile groups is shifted with respective to geospatial arrangement of the first set of tile groups. This effectively varies geometric arrangement of tile group borders across the first and second sets of tile groups. The system can then apply (independently, and in parallel) the optimization algorithm to the second set of tile groups. After a predetermined number of iterations have been performed (e.g., to ensure that each tile group border in a respective iteration is wholly contained within a tile group in at least one other iteration), the system can generate a digital representation of an environment based on the application of the optimization algorithm to the tile groups in the previously performed iterations. The system may generate this digital representation more quickly (and in some cases with fewer processing resources) than conventional technologies which do not segment the vehicle trace data into tile groups prior to optimization. Relatedly, the digital representation may be smoother/more accurate than digital representations generated by alternative technologies which do not perform multiple iterations of the above-described segmented optimization while shifting geospatial arrangement of the tile groups between iterations.

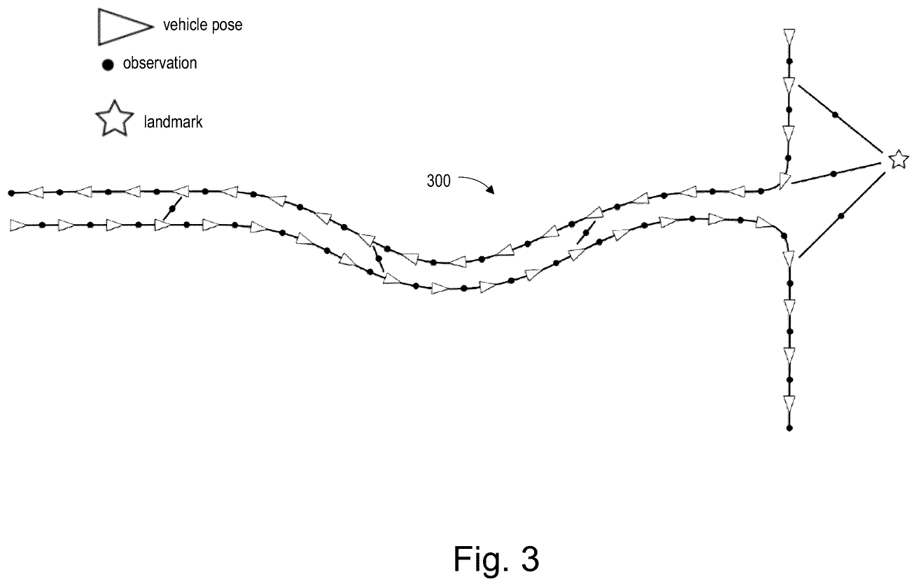

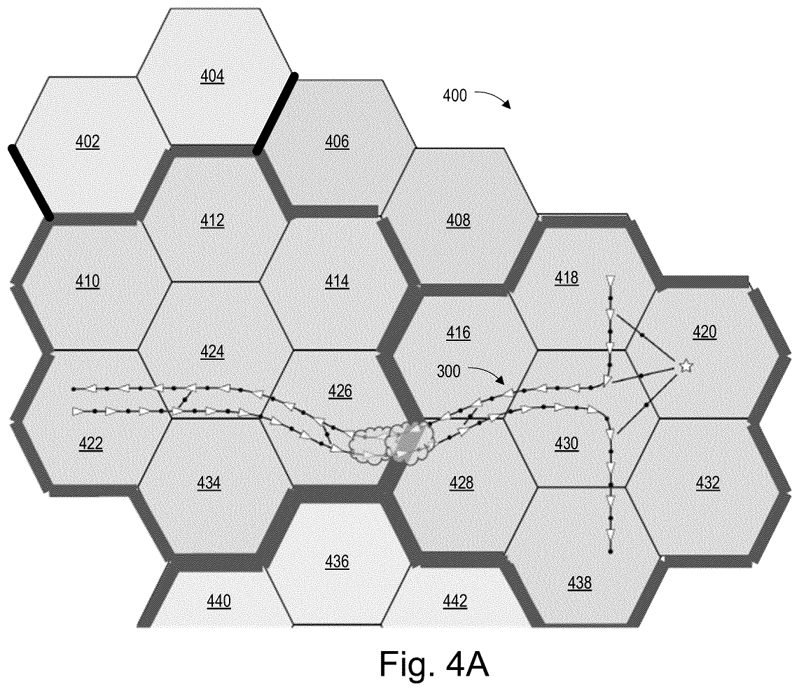

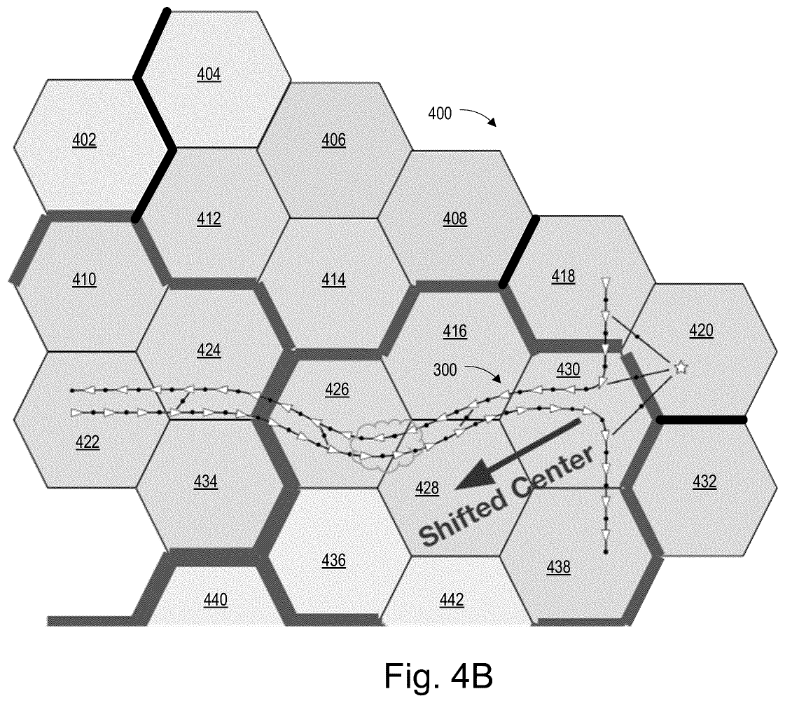

FIGS. 3 and 4A-4B illustrate the above-described process.

Namely, FIG. 3 illustrates a graphical representation 300 of vehicle trace data, in accordance with various embodiments of the presently disclosed technology. As depicted by graphical representation 300, the vehicle trace data may comprise data related to vehicle trajectory/vehicle pose, and observations of landmarks along such vehicle trajectories.

FIG. 4A illustrates the vehicle trace data (as graphically represented by graphical representation 300) segmented into a first set of tile groups.

FIG. 4B illustrates the vehicle trace data (as graphically represented by graphical representation 300) segmented into a second set of tile groups.

As depicted in FIGS. 4A-4B, in some embodiments the first and second sets of tile groups may be arranged on a geospatial grid of hexagonal tiles 400. Here, a respective hexagonal tile of geospatial grid of hexagonal tiles 400 may correspond to a contiguous geographic/geospatial region of the Earth.

Geospatial grids (e.g., geospatial grid of hexagonal tiles 400) are sometimes referred to as discrete global grid systems. The H3 geospatial indexing system is one illustrative example of a discrete global grid system.

In certain embodiments, geospatial grid of hexagonal tiles 400 may comprise a multi-precision hexagonal tiling of a sphere (corresponding to the Earth/globe) with hierarchical indexes. Geospatial grid of hexagonal tiles 400 may be created on the planar faces of a sphere-circumscribed icosahedron (corresponding to the Earth/globe), and individual hexagonal tiles may be projected to the surface of the sphere-circumscribed icosahedron. The projection may implement various processes, including an inverse face-centered polyhedral gnomonic projection. Geospatial grid of hexagonal tiles 400 may also include a coordinate reference system (CRS). The CRS may correspond with spherical coordinates of the WGS84/EPSG: 4326 authalic radius. In some embodiments, geospatial grid of hexagonal tiles 400 may be constructed on the sphere-circumscribed icosahedron by recursively creating increasingly higher precision hexagonal tiles until a predetermined resolution is achieved.

As depicted in FIGS. 4A-4B, in some embodiments a respective tile group may comprise a cluster of adjacent hexagonal tiles on geospatial grid of hexagonal tiles 400. In certain of these embodiments (and as depicted in FIGS. 4A-4B), the cluster of adjacent hexagonal tiles may comprise a central hexagonal tile surrounded by six hexagonal tiles adjacent the central hexagonal tile. It should be understood that some tile groups are cut-off in FIGS. 4A-4B for ease of visual representation.

As depicted in FIG. 4A (which segments the vehicle trace data into a first set of tile groups), a first tile group in the first set of tile groups may comprise tiles 410, 412, 414, 422, 424 (i.e., the central hexagonal tile in this tile group), 426, and 434.

A second tile group in the first set of tile groups may comprise tiles 416, 418, 420, 428, 430 (the central hexagonal tile in this tile group), 432, and 438.

A third tile group in the first set of tile groups may comprise tiles 402, 404, and five additional tiles not depicted in FIGS. 4A-4B for brevity.

A fourth tile group in the first set of tile groups may comprise tiles 406, 408, and five additional tiles not depicted in FIGS. 4A-4B for brevity.

A fifth tile group in the first set of tile groups may comprise tiles 436, 440, 442, and four additional tiles not depicted in FIGS. 4A-4B for brevity.

As depicted in FIG. 4A, the vehicle trace data (as graphically represented by graphical representation 300) may span/cross a border between the first tile group in the first set of tile groups and the second tile group in the first set of tiles groups. More particularly, the vehicle trace data may span/cross a border between tile 426 (of the first tile group in the first set of tile groups) and tile 428 (of the second tile group in the first set of tile groups). As alluded to above, when the first tile group in the first set of tile groups and the second tile group in the first set of tile groups are optimized independently, discontinuities can appear at the borders between them. For example, digital representations of landmarks (e.g., lane markers, road boundaries, etc.) may shift with respective to each other across these independently-optimized adjacent tile groups.

As described above, to address this challenge raised by segmenting vehicle trace data into tile groups, embodiments perform multiple iterations of the above-described segmented optimization while shifting geospatial arrangement of the tile groups between iterations. By shifting geospatial arrangement of the tile groups between iterations, embodiments can effectively “smooth out” discontinuities at tile group borders by effectively varying tile group borders across iterations. In certain examples, embodiments may perform a predetermined number of iterations to ensure that each tile group border in a respective iteration is wholly contained within a tile group (and thus not a tile group border) in at least one other iteration.

This geospatial arrangement shift is illustrated by comparing FIG. 4A (illustrating the first set of tile groups) to FIG. 4B (illustrating the second set of tile groups).

As depicted in FIG. 4B, geospatial arrangement of the second set of tile groups is shifted with respect to geospatial arrangement of the first set of tile groups. This can be achieved by shifting central hexagon tiles for the second set of tile groups by at least one tile position on geospatial grid of hexagonal tiles 400 with respect to central hexagon tiles for the first set of tile groups.

Namely (and as depicted in FIG. 4B), a first tile group in the second set of tile groups may comprise tiles 410, 422, 424 (the central hexagonal tile in this tile group), 434, and two additional tiles not depicted in FIGS. 4A-4B for brevity.

A second tile group in the second set of tile groups may comprise tiles 416, 426, 428 (the central hexagon tile in this tile group), 436, 438, and 442.

It should be understood that other tiles in FIG. 4B may belong to additional tile groups in the second set of tile groups.

As depicted, the vehicle trace data (as graphically represented by graphical representation 300) may span/cross a border between the first tile group in the second set of tile groups and the second tile group in the second set of tiles groups. More particularly, the vehicle trace data may span/cross a border between tile 424 (of the first tile group in the second set of tile groups) and tile 426 (of the second tile group in the second set of tile groups).

Importantly however, and as can be seen in FIG. 4B, the portion of vehicle trace data that had spanned/crossed the border between the first tile group in the first set of tile groups and the second tile group in the first set of tile groups (i.e., the vehicle trace data spanning the border between tile 426 and tile 428) is now wholly contained within the second tile group in the second set of tile groups as a result of the shifted geospatial arrangement. Accordingly, optimization of the second tile group in the second set of tile groups can effectively “smooth out” discontinuities at the (previous) border between the first tile group in the first set of tile groups and the second tile group in the first set of tile groups.

It may be noted however that the first set of tile groups and the second set of tile groups still share some common tile group borders. For example, the border between tile 408 and tile 416 is a tile group border in both the first set of tile groups and the second set of tile groups. Accordingly, additional iterations may be required to “smooth out” potential discontinuities associated with vehicle trace data spanning/crossing this border. Namely, for the specific geometric configuration of FIGS. 4A-4B (i.e., tile groups comprising a central hexagon tile surrounded by six adjacent hexagonal tiles), five total iterations may be needed to ensure that that each tile group border in a respective iteration is contained within a tile group in at least one other iteration. Importantly, this number of iterations may be fewer than with tiles/tile groups of different shapes (e.g., rectangles). Accordingly, by utilizing respective tile groups comprising a central hexagonal tile surrounded by six hexagonal tiles, embodiments can reduce the number of iterations required to ensure that each tile group border in a respective iteration is wholly contained within a tile group in at least one other iteration.

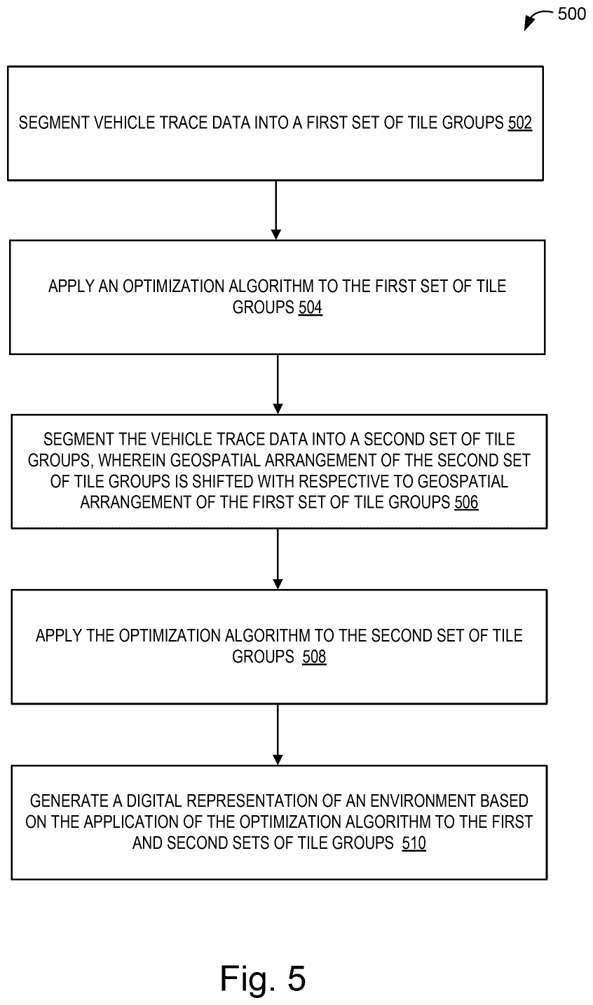

FIG. 5 illustrates an example process 500 that can be performed by a system to optimize vehicle trace data for generating a digital representation of an environment, in accordance with embodiments of the systems and methods described herein. In various embodiments, the system performing example process 500 may be external mapping system 140 from FIGS. 1A-1B.

As depicted, the system may perform operation 502 to segment vehicle trace data into a first set of tile groups.

As described above, vehicle trace data may be obtained from connected vehicles (e.g., thousands of connected vehicles), including vehicle 100 from FIGS. 1A-1B. The vehicle trace data may comprise any combination of: (1) data related to three-dimensional (3D) trajectories of the connected vehicles; and (2) data related to landmarks observed by the connected vehicles along their 3D trajectories.

As described above, in some embodiments the first set of tile groups may be arranged on a geospatial grid of hexagonal tiles. Here, a respective tile may correspond to a contiguous geographic/geospatial region of the Earth (see e.g., FIGS. 4A-4B for an illustrative example).

As described above, in some embodiments a respective tile group may comprise a cluster of adjacent hexagonal tiles on the geospatial grid of hexagonal tiles. In certain of these embodiments, the cluster of adjacent hexagonal tiles may comprise a central hexagonal tile surrounded by six hexagonal tiles adjacent the central hexagonal tile (see e.g., FIGS. 4A-4B for an illustrative example).

After segmenting the vehicle trace data into the first set of tile groups, the system can perform operation 504 to apply an optimization algorithm to the first set of tile groups.

As described above, in various embodiments applying the optimization algorithm to the first set of tile groups may comprise independently applying the optimization algorithm to individual tile groups in the first set of tile groups. In some embodiments, the system may perform these independent optimizations in parallel.

As described above, in certain embodiments the optimization algorithm may comprise simultaneous localization and mapping (SLAM) algorithm, or similar optimization algorithm.

After, applying the optimization algorithm to the first set of tile groups, the system can perform operation 506 to segment the vehicle trace data into a second set of tile groups, wherein geospatial arrangement of the second set of tile groups is shifted with respective to geospatial arrangement of the first set of tile groups.

Where the first set of tile groups was arranged on a geospatial grid of hexagonal tiles, the second set of tile groups may be arranged on the (same) geospatial grid of hexagonal tiles. Similarly, where a respective tile group in the first set of tile groups comprised a central hexagonal tile surrounded by six hexagonal tiles adjacent the central hexagonal tile, a respective tile group in the second set of tile groups may also comprise a central hexagonal tile surrounded by six hexagonal tiles adjacent the central hexagonal tile. In these embodiments, central hexagon tiles for the second set of tile groups may be shifted by at least one tile position on the geospatial grid of hexagonal tiles with respect to central hexagon tiles for the first set of tile groups (see e.g., FIGS. 4A-4B for an illustrative example).

After segmenting the vehicle trace data into a second set of tile groups, the system can perform operation 508 to apply the optimization algorithm to the second set of tile groups. As described above, in various embodiments applying the optimization algorithm to the second set of tile groups may comprise independently applying the optimization algorithm to individual tile groups in the second set of tile groups. In some embodiments, the system may perform these independent optimizations in parallel.

After applying the optimization algorithm to the second set of tile groups, the system can perform operation 510 to generate a digital representation of an environment based on the application of the optimization algorithm to the first and second sets of tile groups. In various embodiments, the environment may comprise a road network.

As described above, in certain embodiments the system may perform a predetermined number of iterations of segmenting the vehicle trace data into tile groups and applying the optimization algorithm to the respective iterations of tile groups. In some cases, this predetermined number of iterations may ensure that each tile group border in a respective iteration is wholly contained within a tile group in at least one other iteration (see e.g., FIGS. 4a-4B for an illustrative example). For example, where a respective tile group comprises a central hexagonal tile surrounded by six hexagonal tiles adjacent the central hexagonal tile, performing five iterations can ensure that that each tile group border in a respective iteration is wholly contained within a tile group in at least one other iteration. This number of iterations may be fewer than with tiles/tile groups of different shapes (e.g., rectangles). Accordingly, by utilizing respective tile groups comprising a central hexagonal tile surrounded by six adjacent hexagonal tiles, embodiments can reduce the number of iterations required to ensure that each tile group border in a respective iteration is wholly contained within a tile group in at least one other iteration.

For example, in various embodiments (e.g., where a respective tile group comprises a central hexagonal tile surrounded by six hexagonal tiles adjacent the central hexagon tile), the system can segment the vehicle trace data into a third set of tile groups, wherein geospatial arrangement of the third set of tile groups is shifted with respective to geospatial arrangement of the first and second sets of tile groups. The system can then applying the optimization algorithm to the third set of tile groups. These two steps may be considered a third iteration.

After the third iteration, the system can segment the vehicle trace data into a fourth set of tile groups, wherein geospatial arrangement of the fourth set of tile groups is shifted with respective to geospatial arrangement of the first, second, and third sets of tile groups. The system can then apply the optimization algorithm to the fourth set of tile groups. These two steps may be considered a fourth iteration.

After the fourth iteration, the system can segment the vehicle trace data into a fifth set of tile groups, wherein geospatial arrangement of the fifth set of tile groups is shifted with respective to geospatial arrangement of the first, second, third, and fourth sets of tile groups. The system can then apply the optimization algorithm to the fifth set of tile groups. These two steps may be considered a fifth iteration.

Accordingly, the system can generate the representation of the environment based on the application of the optimization algorithm to the first, second, third, fourth, and fifth sets of tile groups.

As described above, by shifting geospatial arrangement of the tile groups between iterations, the system can effectively “smooth out” discontinuities at tile group borders of a respective iteration effectively varying tile group borders across iterations. In certain examples (and as just described), embodiments may perform a predetermined number of iterations to ensure that each tile group border in the respective iteration is wholly contained within tile group (and thus not a tile group border) in at least one other iteration.

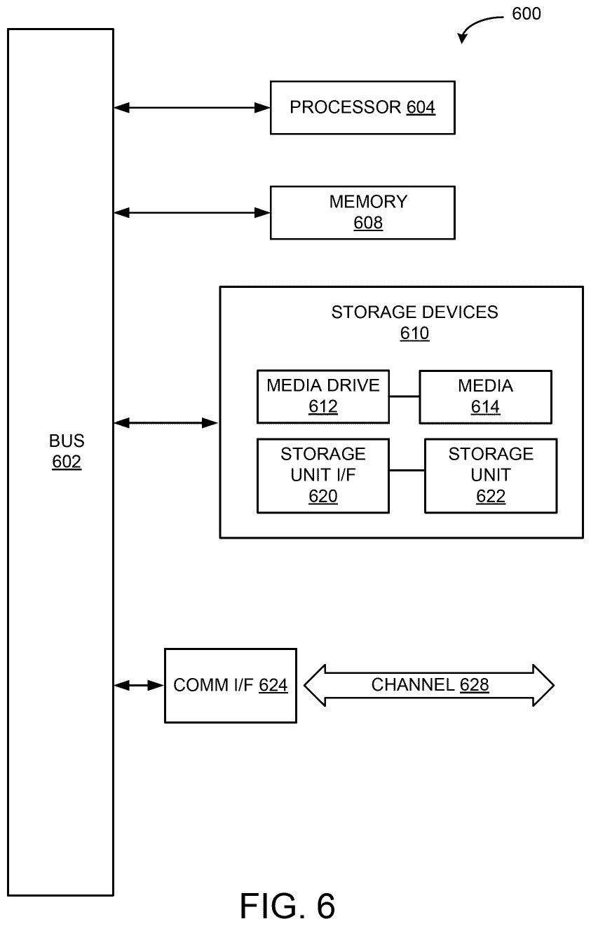

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor, and/or any one or more of the components making up a user device, a user system, and a non-decrypting cloud service. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
segmenting vehicle trace data into a first set of tile groups;
applying an optimization algorithm to the first set of tile groups;
segmenting the vehicle trace data into a second set of tile groups, wherein geospatial arrangement of the second set of tile groups is shifted with respective to geospatial arrangement of the first set of tile groups;
applying the optimization algorithm to the second set of tile groups; and
generating a digital representation of an environment based on an application of the optimization algorithm to the first and second sets of tile groups.

2. The method of claim 1, wherein applying the optimization algorithm to the first set of tile groups comprises independently applying the optimization algorithm to individual tile groups in the first set of tile groups.

3. The method of claim 1, wherein:
the first and second tile groups are arranged on a geospatial grid of hexagonal tiles; and
a respective tile group comprises a cluster of adjacent hexagonal tiles on the geospatial grid of hexagonal tiles.

4. The method of claim 3, wherein a respective hexagonal tile on the geospatial grid of hexagonal tiles corresponds to a contiguous geographic region of the environment.

5. The method of claim 3, wherein the cluster of adjacent hexagonal tiles comprises a central hexagonal tile surrounded by six hexagonal tiles adjacent the central hexagonal tile.

6. The method of claim 5, wherein central hexagon tiles for the second set of tile groups are shifted by at least one tile position on the geospatial grid of hexagonal tiles with respect to central hexagon tiles for the first set of tile groups.

7. The method of claim 1, further comprising:
segmenting the vehicle trace data into a third set of tile groups, wherein geospatial arrangement of the third set of tile groups is shifted with respective to geospatial arrangement of the first and second sets of tile groups;
applying the optimization algorithm to the third set of tile groups;
segmenting the vehicle trace data into a fourth set of tile groups, wherein geospatial arrangement of the fourth set of tile groups is shifted with respective to geospatial arrangement of the first, second, and third sets of tile groups;
applying the optimization algorithm to the fourth set of tile groups;
segmenting the vehicle trace data into a fifth set of tile groups, wherein geospatial arrangement of the fifth set of tile groups is shifted with respective to geospatial arrangement of the first, second, third, and fourth sets of tile groups; and
applying the optimization algorithm to the fifth set of tile groups.

8. The method of claim 7, wherein generating the representation of the environment based on the application of the optimization algorithm to the first and second sets of tile groups comprises:
generating the representation of the environment based on the application of the optimization algorithm to the first, second, third, fourth, and fifth sets of tile groups.

9. The method of claim 1, wherein the optimization algorithm comprises a simultaneous localization and mapping (SLAM) algorithm.

10. The method of claim 1, wherein the vehicle trace data is obtained from connected vehicles.

11. The method of claim 10, wherein the vehicle trace data comprises at least one of:
data related to three-dimensional (3D) trajectories of the connected vehicles; or
data related to landmarks observed by the connected vehicles along their 3D trajectories.

12. A system comprising:
one or more processing resources; and
non-transitory computer-readable medium, coupled to the one or more processing resources, comprising stored therein instructions that when executed by the one or more processing resources cause the system to:
segment vehicle trace data into a first set of tile groups;
independently apply an optimization algorithm to individual tile groups in the first set of tile groups;
segment the vehicle trace data into a second set of tile groups, wherein geospatial arrangement of the second set of tile groups is shifted with respective to geospatial arrangement of the first set of tile groups;
independently apply the optimization algorithm to individual tile groups in the second set of tile groups; and
generate a representation of an environment based on an application of the optimization algorithm to the first and second sets of tile groups.

13. The system of claim 12, wherein:
the first and second tile groups are arranged on a geospatial grid of hexagonal tiles; and
a respective tile group comprises a cluster of adjacent hexagonal tiles on the grid of hexagonal tiles.

14. The system of claim 13, wherein a respective hexagonal tile on the geospatial grid of hexagonal tiles corresponds to a contiguous geographic region of the environment.

15. The system of claim 13, the cluster of adjacent hexagonal tiles comprises a central hexagonal tile surrounded by six hexagonal tiles adjacent the central hexagonal tile.

16. The system of claim 15, wherein central hexagon tiles for the second set of tile groups are shifted by at least one tile position on the geospatial grid of hexagonal tiles with respect to central hexagon tiles for the first set of tile groups.

17. The system of claim 12, wherein the non-transitory computer-readable medium comprises further instructions, that when executed by the one or more processing resources, cause the system to:
segment the vehicle trace data into a third set of tile groups, wherein geospatial arrangement of the third set of tile groups is shifted with respective to geospatial arrangement of the first and second sets of tile groups;
independently apply the optimization algorithm to individual tile groups in the third set of tile groups;
segment the vehicle trace data into a fourth set of tile groups, wherein geospatial arrangement of the fourth set of tile groups is shifted with respective to geospatial arrangement of the first, second, and third sets of tile groups;
independently apply the optimization algorithm to individual tile groups in the fourth set of tile groups;
segment the vehicle trace data into a fifth set of tile groups, wherein geospatial arrangement of the fifth set of tile groups is shifted with respective to geospatial arrangement of the first, second, third, and fourth sets of tile groups; and
independently apply the optimization algorithm to individual tile groups in the fifth set of tile groups.

18. The system of claim 17, wherein generating the representation of the environment based on the application of the optimization algorithm to the first and second sets of tile groups comprises:
generating the representation of the environment based on the application of the optimization algorithm to the first, second, third, fourth, and fifth sets of tile groups.

19. A method comprising:
segmenting vehicle trace data into a first set of tile groups;
independently applying an optimization algorithm to individual tile groups in the first set of tile groups;
segmenting the vehicle trace data into a second set of tile groups, wherein:
the first and second tile groups are arranged on a geospatial grid of hexagonal tiles,
a respective tile group comprises a central hexagonal tile surrounded by six hexagonal tiles adjacent the central hexagonal tile, and
central hexagon tiles for the second set of tile groups are shifted by at least one tile position on the grid of hexagonal tiles with respect to central hexagon tiles for the first set of tile groups;
independently applying the optimization algorithm to individual tile groups in the second set of tile groups; and
generating a representation of an environment based on the application of the optimization algorithm to the first and second sets of tile groups.

20. The method of claim 19, wherein a respective hexagonal tile on the grid of hexagonal tiles corresponds to a contiguous geographic region of the environment.
